(19) United States
(12) Patent Application Publication
(10) Pub. No.: US 2009/0138411 A1
(43) Pub. Date: May 28, 2009

(54) METHOD OF TRADING DERIVATIVE INVESTMENT PRODUCTS BASED ON AN INDEX ADAPTED TO REFLECT THE RELATIVE PERFORMANCE OF TWO DIFFERENT INVESTMENT ASSETS

(75) Inventor: Dennis M. O'Callahan, Evanston, IL (US)

Correspondence Address: K&L Gates LLP, P.O. Box 1135, CHICAGO, IL, 60690, US

(73) Assignee: CHICAGO BOARD OPTIONS EXCHANGE, INCORPORATED, Chicago, IL (US)

(21) Appl. No.: 12/326,582

(22) Filed: Dec. 2, 2008

Related U.S. Application Data
(63) Continuation of application No. 10/319,157, filed on Dec. 12, 2002, now abandoned.

(51) Int. Cl. G06Q 40/00

(52) U.S. Cl. 705/36 R

(57) ABSTRACT

Methods of creating indexes to reflect the relative performance of a pair of investment assets are provided. Also provided are methods of trading derivative investment products based on such an indexes. According to embodiments the invention index values are calculated based on the single day percentage change in the value of each asset, the cumulative relative change in the value of each asset, or the average daily relative change in the value of each asset. According to an embodiment all positions in derivative investment products based on an index are settled in cash at the end of each trading session, and the index is reset to a base value prior to trading the derivative investment products in the next session.

### PRIORITY CLAIM

This application claims the benefit of U.S. patent application Ser. No. 10/319,157, filed Dec. 12, 2002, entitled “Method Of Trading Derivative Investment Products Based On An Index Adapted To Reflect The Relative Performance Of Two Different Investment Assets,” the entire contents of which are hereby incorporated by reference.

### BACKGROUND OF THE INVENTION

The present invention relates to a method of calculating an index value based on the relative performance of a pair of individual assets. The invention further encompasses a method of trading performance futures contracts based on such an index.

Futures contracts are well known investment instruments. In traditional futures contracts a buyer purchases the right to receive delivery of an underlying commodity or asset on a fixed date in the future. A seller agrees to deliver the commodity or asset on the specified date for a given price. Typically, the seller will demand a premium over the prevailing market price at the time the contract is made in order to cover the cost of carrying the commodity or asset until the delivery date.

Futures contracts originated around the buying and selling of agricultural commodities. However, they rapidly spread to other commodities and intangible assets as well. Today futures contracts are traded on everything from pork bellies to stock market indices. What is more, the purpose behind futures contracts has also evolved over time. In today's marketplace futures contracts act more as investment vehicles rather than just serving as mechanisms for securing future delivery of a product at a set price. In today's futures trading markets investors take risk positions based on anticipated movements in the price of the underlying commodity or asset. For example, an investor may take a long position in a futures contract in anticipation that the price of the underlying asset will rise prior to the expiration of the contract. By taking a long position the investor has secured delivery of the underlying asset at a designated time in the future at a designated price. If the market price of the asset moves higher than the price the investor agreed to pay, the investor can turn around and sell his interest in the underlying asset at the current higher price and realize a profit. Similarly, an investor may take a short position in a futures contract in the belief that the price of the underlying asset will fall. In this case, the investor is obligated to deliver the underlying asset on the delivery date. If the price of the underlying asset falls, the purchaser on the other side of the transaction is obligated to pay the higher price for the asset established by the contract. The investor holding the short position can then purchase the asset at the lower prevailing market price and deliver it to the purchaser in return for the higher specified contract price.

Although futures contracts generally confer the obligation to deliver the underlying asset on the specified delivery date, the actual asset need not ever change hands. Instead, futures contracts may be settled in cash. Rather than delivering the underlying asset, cash settlement requires that the difference between the market price and the contract price be paid by one investor to the other, depending on which direction the market price has moved. If the prevailing market price is higher than the contract price, the investor who has taken a short position in the futures contract must pay the difference between the market price and the contract price to the long investor. Conversely, if the market price has fallen, the long investor must pay the difference to the short investor in order to settle the contract.

Cash settlement allows futures contracts to be created based on more abstract assets such as market indices. Rather than requiring the delivery of a market index (a concept that has no meaning) or delivery of the individual components that make up the index at a set price on a given date, index futures can be settled in cash. In this case the difference between the contract price and the price of the underlying asset is exchanged between the investors to settle the contract. Traditionally, cash settlement occurs on the last day of trading for a particular contract. On a day to day basis, however, an exchange may settle margin accounts on a “marked-to-market” basis at the end of each trading day.

At the end of each trading session, a futures contract will be “marked” to the closing price of the futures contract. Note, the marked price is the actual closing price of the futures contract, not the closing price of the underlying asset. The difference between the marked price and the contract price for the underlying asset is then credited to or debited from the margin accounts of those investors who have taken positions in the particular futures contract. For example, if an investor is long 1 S&P 500 December 900 futures contract, and the December S&P 500 futures close at a price of 905, the clearing corporation for the exchange on which the contract is traded will “mark” the Dec 900 future to the 905 Dec futures closing price, and credit the investor's account $5. If instead the Dec futures drop in value to 895, the clearing corporation will debit the account of the investor with the long position $5 and may issue a margin call. In determining whether to issue a margin call, the clearing corporation calculates “variation margin” on a daily basis. The situation is exactly reversed for investors who have taken a short position in the same futures contract, with the short investor's account being debited if the marked-to-market price is above the contract price and credited if the marked-to-market price is below the contract price.

Typical futures contracts provide a mechanism for investors to protect against or capitalize on changes in the price of the underlying asset. Each futures contract stands on its own and is unaffected by movement in the price of other commodities, stocks, bonds, and the like, except so far as changes in the price of other assets influence the price of the particular asset underlying the futures contract. At the present time there exists no futures contract investment product which satisfactorily reflects the relative performance between two separate assets over an extended period of time. A problem with existing relative performance products is that the performance results become skewed as the relative value of the underlying assets change. The performance results of such products will accurately reflect the relative performance of the two assets during the entire period from the inception of the contract up to the present time, but they will not accurately reflect the relative performance of the assets for time periods starting after the original inception date of the contract.

Alternately, an investor may independently take equal and opposite positions in both assets individually. As the value of each asset changes, the investor's relative stake in each investment changes as well. The investor must continually alter his holdings in order to maintain a desired ratio between the two assets, thereby increasing the investor's transaction costs. Furthermore, traditional futures contracts expire on a given date. An investor who wants to maintain his or her position in a particular market after the expiration of his or her futures contracts holdings, must regularly roll his or her holdings over into new contracts. Again, this additional trading drives up the investor's investment costs.

To avoid these problems, a new investment instrument is needed which allows investors to take a position in relation to two separate assets in an easy straight forward manner so that the investor may capitalize on differences between the performance of the two assets. Preferably such an instrument would be in the form of a futures contract based on a customized index designed to reflect the relative performance of two individual assets. Such an instrument could be configured to have a predefined expiration date, or could be designed to continue indefinitely. Since the contract would be based on an index rather than a tangible asset, cash settlement of the instrument would be preferred. Further the index on which the relative performance futures contract is based could be reset to a predefined value on a regular basis to reestablish a basis for comparison between the two assets so that the index always reflects the relative performance of the two assets since the time the index was last reset.

### SUMMARY OF THE INVENTION

The present invention relates to a method of creating an index adapted to reflect the relative performance between a pair of investment assets as well as a method of trading futures contracts based on such an index.

According to an embodiment of the invention an index is created that reflects the relative performance of a first asset and a second asset. The value of each asset is continually monitored over time. A dynamic index value is calculated according to a formula which reflects the relative changes in the price of the two assets over time. The index is then reset to a specified value at predetermined regular intervals regardless of the prevailing value of each asset.

Another embodiment of a performance index according to the present invention tracks the cumulative performance of two different assets. Such an index measures the relative percentage change in the price of each asset over a specified time period. The index value represents the average daily differential return of the two assets over the defined time period.

In still another embodiment a performance index tracks the average daily performance of two different assets over a period of time. Such an index captures the average daily return over a defined period. The average daily performance index provides an underlying index for futures and options contracts designed to give exposure to a first asset's outperformance (or under performance) of a second asset.

According to another aspect of the invention, a method of trading futures contracts is provided. In this method the futures contracts are based on an index that reflects the relative performance of a pair of investment assets. The first step of the method involves creating an index which accurately reflects the relative performance between the two assets. Next, a futures contract is created between a first investor and a second investor wherein the first investor takes a long position relative to the index and the second investor takes a short position relative to the index. In an embodiment of the invention the two investor's positions are settled in cash, at the price of the underlying index, at the end of each trading session. After accounts have been settled at the end of a trading session, the index is reset to a predefined base value prior to the beginning of the next trading session. According to the invention, such performance based futures contracts may include a fixed expiration date or they may be created to continue indefinitely. In an alternative embodiment of the invention an index measures the cumulative relative performance of a first asset compared to a second asset. Derivative contracts based on this type of index may be cash settled upon expiration. Yet another embodiment of a performance oriented index tracks the average relative performance of two assets.

Thus, according to various embodiments of the present invention, the present invention provides a mechanism whereby investors may take a position with regard to two independent assets with a single transaction. The investment in a performance future reflects the investor's outlook as to the probable future performance of one asset relative to the other. Furthermore, an investor may establish and maintain a position without constantly readjusting his or her holdings as the value of each asset changes. The investor may also maintain his or her position for an extended period of time without the necessity of rolling over his holdings to extend his position past an arbitrary expiration date. Further, investors may take positions regarding the cumulative performance of one asset as opposed to another, or the average daily performance of the one asset compared to the other.

Additional features and advantages of the present invention are described in, and will be apparent from, the following Detailed Description of the Invention and the figures.

### BRIEF DESCRIPTION OF THE FIGURES

FIG. 1 is a flowchart showing a method of trading performance futures contracts according to the present invention.

FIG. 2 is a chart showing the performance of a first asset, a second asset and a performance index according to the present invention over a five-day period.

FIGS. 3(a), 3(b), and 3(c) are graphical representations of the performance of the first asset, the second asset and the performance index for the same five-day period as the chart in FIG. 2.

FIG. 4 is a chart showing the daily net gain/loss and cumulative net gain/loss for two investors who have taken opposite positions in a performance futures contract.

FIG. 5 is a chart showing the performance of a first asset, a second asset and a cumulative performance index according to an embodiment of the present invention over a five-day period.

FIGS. 6(a), 6(b), and 6(c) are graphical representations of the performance of the first asset, the second asset and the cumulative performance index for the same five-day period as the chart in FIG. 5.

FIG. 7 is a chart showing the performance of a first asset, a second asset and a average daily performance index according to an embodiment of the present invention over a five-day period.

FIGS. 8(a), 8(b), and 8(c) are graphical representations of the performance of the first asset, the second asset and the average daily performance index for the same five-day period as the chart in FIG. 7.

### DETAILED DESCRIPTION OF THE INVENTION

The present invention relates to creating and trading futures contracts specially adapted to capture the relative performance between two different assets. The invention further provides a method of creating an index on which such futures contracts may be based. For descriptive purposes the specially adapted futures contracts of the present invention will be referred to as “performance futures”, and an index created according to the invention method will be referred as a “performance index”. Those skilled in the art will recognize that futures contracts having features similar to those described herein and indices which reflect the relative performance of two or more assets, but which are given labels other than performance futures and performance indices will nonetheless fall within the scope of the present invention.

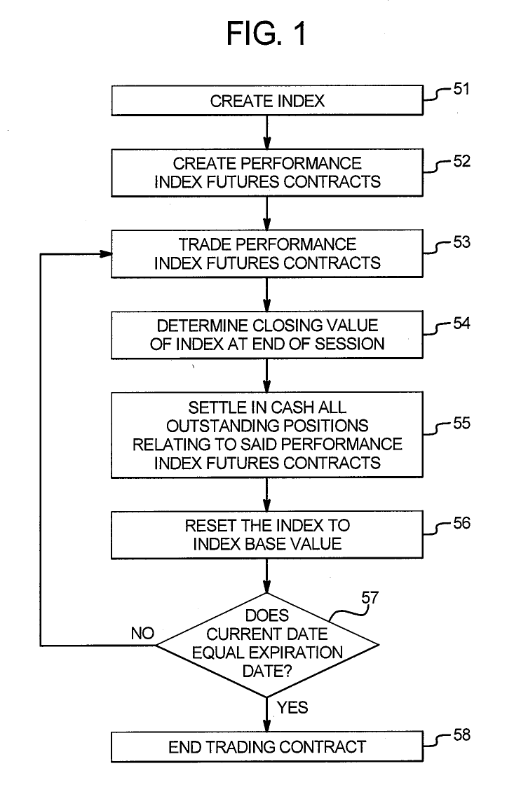

FIG. 1 shows a flow chart of a method of trading performance futures according to the present invention. The method begins at step S1 with the creation of a performance index. This step requires the selection of a pair of assets on which the index is to be based. The assets may be any asset, including, but not limited to, commodities, securities, derivatives or economic indicators. Typically, there will be some logical relationship between the selected assets so that an investor may make an informed prediction as to whether one asset will outperform the other and invest in a performance futures contract based on the index. For example, an index may be created which reflects the performance of the S&P 500, a broad market gauge, against the narrower Dow Jones Industrial Average. According to the invention, investors may make investments based on whether they believe the S&P 500 will outperform the Dow or vice versa. Similarly, an index might be created between the share price of a first company's stock and that of another company in the same industry, in order to capture the relative performance of related manufacturers. A strong logical relationship between the selected assets is more likely to attract investors to invest in an index, but is not absolutely necessary. Assets may be selected for any arbitrary reason, and the logical connection between the two assets may be very tenuous indeed, or even non existent.

Once a pair of assets has been selected, it is necessary to develop a formula for generating an index value which reflects the relative performance of the two assets over time. According to a preferred embodiment of the invention, the performance index value is calculated using the following formula:

PI=100+{% Δ_{S.D.}Asset A−% Δ_{S.D.}Asset B}

wherein % Δ_{S.D.} Asset A represents the single day percentage change in the value of the first asset and % Δ_{S.D.} Asset B represents the single day percentage change in the value of the second asset. The single day percent change in Assets A and B is calculated by subtracting the asset's previous day's closing price from the asset's current price, dividing the result by the previous day's closing price and multiplying by 100, or

$$\% {Δ}_{S . D .} = \frac{{P}_{I} - {P}_{c}}{{P}_{c}} \times 100$$

where Pt is the current price of the asset at time t and Pc is the closing price of the asset the previous day. Additionally, the percentage change of each asset may be weighted differently. For example, if it can be expected that the value of the two assets will change at a ratio of approximately 3:2, the single day percentage change of Asset A may be multiplied by a weighting multiplier of 2, and that of Asset B may be multiplied by a weighting multiplier of 3.

Step S2 of the method disclosed in FIG. 1 calls for the creation of performance futures contracts based on the performance index created in step S1. Creation of a performance futures contract requires the participation of two investors. The first investor agrees to take a “long” position (anticipating that the index value will rise) and the second investor must take a corresponding “short” position (anticipating that the index value will fall). The investor taking the short position agrees to pay to the holder of the long position an amount equal to the change in value of the index times some multiplier if the index value rises. Conversely, the investor taking the long position agrees to pay an amount equal to the change in value of the index times the same multiplier to the holder of the short position if the index loses value.

In addition to entering new performance futures contracts at their creation, investors can trade into and out of the performance futures market by buying and selling existing contracts, as indicated by step S3.

A feature of the performance futures contracts created and traded according to this embodiment of the present invention is that they are cash settled at the end of each trading session. As shown in step S4 the value of the performance index is determined at the end of each trading session and all positions taken relative to the index are settled in cash. Thus, if the index closes above 100 (the starting point for each session) those investors who took a long position relative to the index will be credited an amount equal to the change in the value of the index multiplied by a multiplier. Likewise, those investors who took a short position relative to the index will be charged an amount equal to the change in the value of index multiplied by the same multiplier. If the index closes lower rather than higher, the same settlement process takes place, only the roles are reversed. The investors who took a short position are paid and the investors who took a long position are charged. Once the accounts have been settled the index is reset to 100 prior to the opening of the next trading session, as indicated in step S6.

Once the index is reset, a determination must be made as to whether the expiration date of the performance futures contract has been reached. As shown in decision step S7, if the present date equals the expiration date of the futures contract, then trading on the contract ends at step S8. Otherwise, if the contract's expiration date has not been reached, the process returns to step S3 where trading on the performance futures contract may begin again at the opening of the next trading session. Accounts with open positions are settled again at the end of the next session and the process continues until the performance futures contract expires.

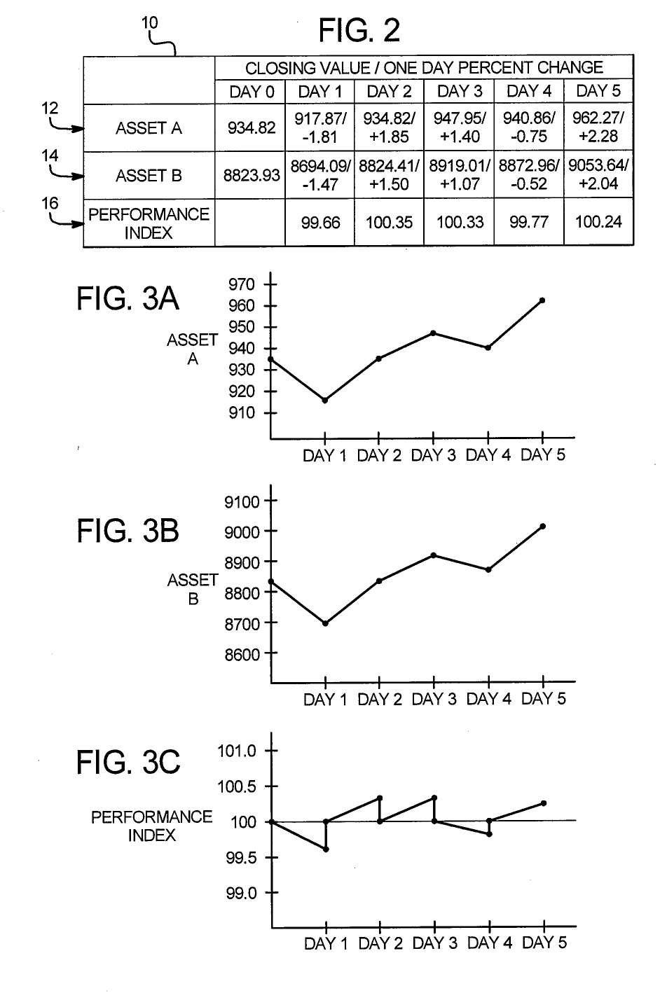

An example of the operation of a performance futures contract based on a performance index according to the present invention will now be described in relation to FIGS. 2-4. FIG. 2 shows a chart 10 which displays the daily performance of a first asset 12, a second asset 14, and a performance index 16 derived from the relative performance of the first and second assets. The chart 10 shows the closing price of each asset and the closing value of the performance index for five consecutive days, along with the percentage change in the value of each asset from day to day. The closing price of Day 0 is provided in order to calculate the percentage change in the first and second assets on Day 1.

FIGS. 3(a), 3(b), and 3(c) show the opening/closing values of the first and second assets and the performance index in graphical form for the same five day period covered by the chart in FIG. 2.

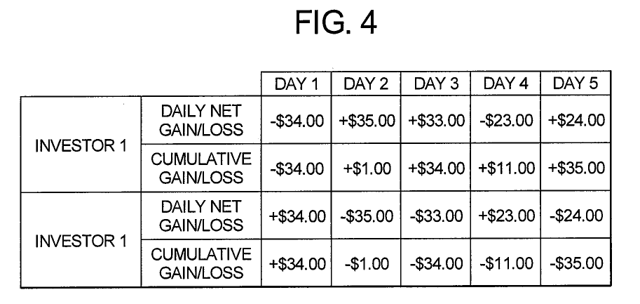

Finally, FIG. 4 is a chart showing the daily net gain/loss and the cumulative gain/loss for two investors who have taken opposite positions in a performance index futures contract. Investor 1 has taken a long position relative to the performance index, and Investor 2 has taken a short position. In the example, a single contract having a value of 100 times the index value will be considered. Since the index value begins at 100, each investor has a $10,000 interest in the index. The contract is cash settled at the end of each trading session. Therefore, if the index rises during the course of a session, the investor holding a long position relative to the index will be paid an amount equal to the change in value of the index multiplied by 100. The roles are reversed if the index falls during the session. Since the index is reset to 100 before the beginning of each session, each investor starts each day with a $10,000 stake in the index. The cash settlement at the end of each session is charged from and paid to the investors directly, leaving the investors' underlying investment unchanged.

Turning to the chart 10 of FIG. 2, Asset A closed at a value of 934.82 at the end of trading on Day 0, the day before our example begins. Asset B closed at 8823.93 on Day 0. On Day 1, both Asset A and Asset B lost value. Asset A closed at 917.87, a single day percentage change of −1.81%. Asset B dropped to 8694.09, a single day percentage change of −1.47%. Although Asset A and Asset B both declined in value, Asset B outperformed Asset A in that the percentage drop in Asset B was not as great as the percentage drop in Asset A. Applying the formula for calculating the performance index.

P.I.=100+{—1.81−(−1.47)}

Thus, the performance index closed at 99.66 on Day 1.

On Day 2, Asset A closed up to 934.82, a single day percentage change of +1.85. Asset B closed up at 8824.41, a single day percentage change of +1.50. Thus, on Day 2, Asset A outperformed Asset B as indicated by the value of the performance index which closed above 100 on Day 2 at 100.35. Day 3 saw a +1.40% change in the value of Asset A which closed up to 947.95, and a +1.07% change in the value of Asset B, which closed at 8919.01. On Day 3, the performance index closed up at 100.33. On Day 4, Asset A was down −0.75% to 940.86 and Asset B was down −0.52% to 8872.96. Based on the relative performance of Asset A with respect to Asset B, the performance index closed down on Day 4 to 99.77. Finally, on Day 5, both Asset A and Asset B were up. Asset A closed at 962.27, a single day percent change of +2.28% and Asset B was up +2.04% to 9053.64. The performance index was up on Day 5, closing at 100.24.

The performance of Asset A, Asset B and the performance index over the same five day period are shown in graphical form in FIGS. 3(a), 3(b) and 3(c), respectively. In addition to the daily changes in the value of the performance index, a significant characteristic of the graph in FIG. 3(c) is that the value of the performance index is reset to 100 after trading each session. Of course, the index is reset only after accounts have been settled at the end of each trading session. Another interesting point to note is that even on days when both assets moved in the same direction, either increasing or decreasing in value, investors on opposite sides of the performance swap futures contract will have opposite results. If both assets gain value, the long investor will earn money only if Asset A increases in value in a greater percentage than Asset B. If Asset B increases in value a greater amount than Asset A then the short investor makes a profit and the long investor suffers a loss. The situation is the same when both assets lose value. If Asset B loses a greater percentage of its value than Asset A the long investor gains and the short investor loses. If Asset A loses a greater percentage of its value than Asset B then the short investor gains and the long investor loses. Of course, if the assets move in opposite direction during the course of a trading session the long investor will experience a gain and the short investor will suffer a loss if Asset A is the asset that increases in value and Asset B loses value. Conversely, the short investor wins and the long investor loses if Asset B gains and Asset A declines.

FIG. 4 shows the daily net gain and loss as well as the cumulative net gain and loss for investors 1 and 2 over the same five day period for which the market performance of Assets A and B are shown in FIGS. 1 and 2. Note that the net gain/loss for the two investors is completely symmetrical. Whatever amount one investor gains, the other investor loses the same amount. Thus, investors taking opposite long and short positions in a performance futures contract are taking on equal but opposite risk.

Referring back to the table in FIG. 2, we see that the performance index closed 0.34 points below the 100 point base value. Since the performance futures contract provides a multiplier of 100 times the index value, the 0.34 drop in the index translates to a $34.00 gain on the part of Investor 2 who has taken a short position relative to the performance index as shown in the chart in FIG. 4. Investor 1, who is long relative to the index, suffers a $34.00 loss on Day 1. On Day 2 the performance index is up 0.35. Thus, Investor 1 gains $35.00 on the Day 2 and Investor 2 loses $35.00. Cumulatively Investor 1 is up $1.0 and Investor 2 is down $1.0. Day 3 sees a 0.33 gain in the performance index. Accordingly, Investor 1 gains $33.00 for a cumulative gain of $35.00 while Investor 2 loses $33.00 for a cumulative loss of $34.00. On day 4 Asset B outperformed Asset A and the performance index dropped 0.23 points to 99.77. Thus long Investor 1 loses $23.00, bringing his cumulative gain down to $11.00. Short Investor 2, on the other hand, gains the $23.00 on the day, reducing his losses to $11.00. On the final day of our example, Day 5, the performance index goes up to 100.24. Investor 1 receives an additional $24.00 bringing his 5 day cumulative earnings up to $35.00 whereas Investor 2 loses an additional $24.00 bring his cumulative loss to $35.00.

The performance futures contracts of the present invention may be established with a fixed expiration date as with traditional futures contracts or embodiment they may continue on ad infinitum. An advantage of allowing such instruments to continue on indefinitely is that investors are not required to continually re-establish their position every 3 or 6 months as the contracts expire, as is the case with traditional futures contracts. Thus, an investor may maintain a desired position over an extended period of time without incurring additional transaction costs such as brokerage fees and the like.

Furthermore, performance futures contracts based on performance indexes calculated as described herein, allow investors to readily take positions relative to two unrelated assets based on the anticipated relative performance between the two assets. What is more, because the index is reset to a base value every day the investor relative position in each asset remains constant. An investor trying to accomplish the same objective by taking separate independent positions in each asset would be required to constantly adjust his holdings to account for changes in the value in each asset. However, because the performance index of the present invention is based on the daily percentage change in each asset, constant adjustment in the investor's portfolio is not required.

In another embodiment of the invention, an index is created which tracks the cumulative relative performance between a pair of assets. As with the previous embodiment, the assets selected to form a cumulative performance index may be selected from a wide variety of financial instruments spanning many asset classes. The number of possible asset combinations is virtually limitless. Once a pair of assets had been selected the index value is calculated according to the formula

$$CPIndex = 100 + \frac{\% Δ AssetA - \% Δ AssetB}{{T}_{i} - {T}_{o}}$$

Wherein % A Asset A is the percentage change in the value of Asset A since the inception of the index, % A Asset B is the percentage change in the value Asset B since the inception of the index, and the Quantity Ti-TO is the number of days (either trading days or calendar days) which have passed since the inception of the index. Unlike the previous embodiment, this index is not reset after each trading session. Rather according to this embodiment the index tracks the relative performance of the two assets over an extended period of time.

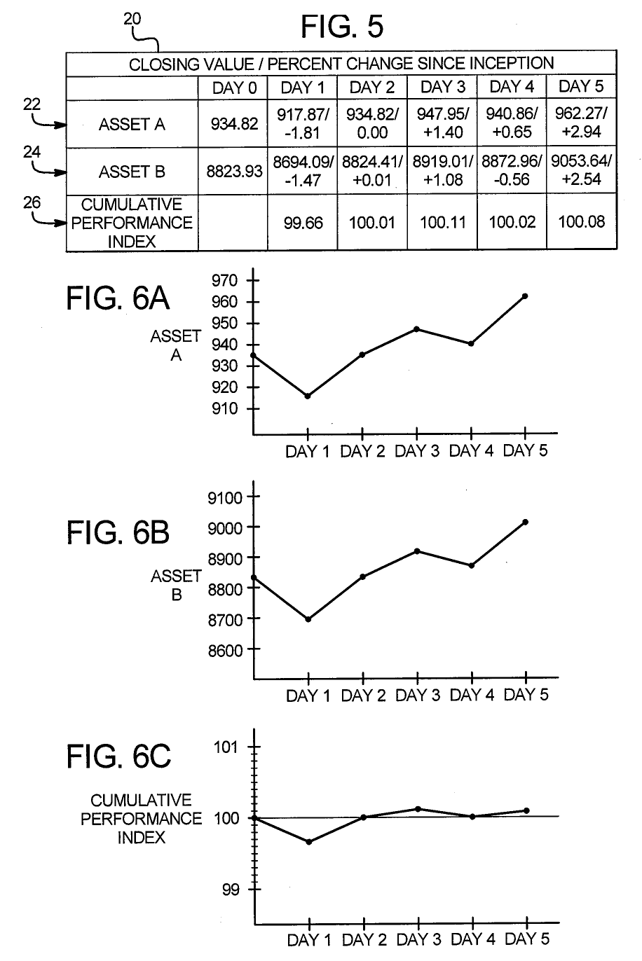

An example of the performance of an index according to this second embodiment of the invention is shown in FIGS. 5 and 6. FIG. 5 is a chart 20 which displays the daily performance of a first Asset 22, a second Asset 24, and the corresponding performance of the cumulative performance index itself 26. The chart 20 of FIG. 5 is very similar to the chart 10 displayed in FIG. 2. The two charts show the daily performance of the same two assets over the same 5 day period. Thus, Asset A had a starting value of 934.82 when the index began. After the first day Asset A closed at a value of 917.87, a percentage change of −1.81% from the opening value. On day 2 Asset A closed at 934.82, 947.95 on day 3, 940.86 on day 4 and 962.27 on day 5, for cumulative percentage changes of −1.81, 0.00, +1.40, +0.65 and +2.94 for days 2, 3, 4 and 5 respectively. Similarly, Asset B began at 8823.93 and closed at 8694.09 on day 1, a −1.47% change. Further Asset B closed at 8824.41 on day 2, 8919.01 on day 3, 8872.96 on day 4 and 9053.64 on day 5, percent changes of +0.01, +1.08, +0.56, and +2.54 respectively. Applying formula (2) above, the cumulative performance index value is calculated to be 99.66 for day 1, 100.01 for day 2, 100.11 for day 3, 100.02 for day 4 and 100.08 for day 5.

For comparison purposes the performance of Assets A and B and the cumulative performance index are shown in line graph form in FIGS. 6(a), 6(b) and 6(c). The charts of FIGS. 6(a) and 6(b) are identical to those of FIGS. 3(a) and 3(b) since they depict the performance of the same assets over the same period of time. The chart in FIG. 6(c), however is significantly different than that of FIG. 3(c) since the two indexes measure substantially different aspect of the relative performance between Assets A and B.

Derivative investment instruments such as futures and options contracts may be traded based on the cumulative performance index just as with traditional market indexes. Such contracts have fixed expiration dates. Unlike the first embodiment, the cumulative performance index is not reset at the end of each trading session. Thus, there is no need for daily cash settlement of all positions. Rather, all accounts are cash settled upon expiration of the derivative contract.

In still another embodiment of the invention an index is created which tracks the average relative daily performance between a pair of assets. Again, the assets may be selected from a wide variety of financial instruments spanning many asset classes, for a virtually limitless number of possible asset combinations. Once a pair of assets has been selected, the index value is calculated according to the formula

$$ADPIndex = 100 + {\sum }_{o}^{i} \frac{\% s . d . Δ AssestA - \% Δ s . d . AssetB}{{T}_{i} - {T}_{o}}$$

wherein % ΔS.D. Asset A is the single day percent change in the value of Asset A, % ΔS.D. Asset B is the single day percent change in the value of Asset B, i is the number of days the index has been in existence and the quantity Ti-To is the length of time over which the index is averaged. As with the previous embodiment, and unlike the first embodiment, this index is not reset at the end of each trading session. According to this embodiment the relative daily performance of the two assets is averaged over time.

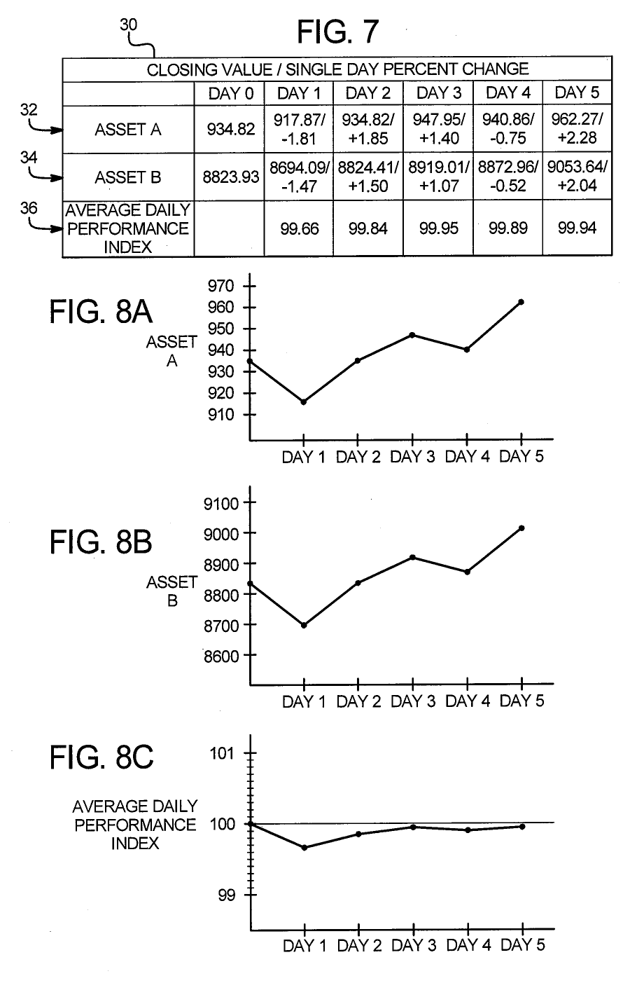

An example of an average daily performance index according to this third embodiment of the invention is shown in FIGS. 7 and 8. FIG. 7 is a chart which displays the daily performance of a first Asset 32, a second Asset 34 and the corresponding performance of the average daily performance index itself 36. Again the chart 30 shown in FIG. 7 is similar to the charts 10 and 20 found in FIGS. 2 and 5. All three charts show the performance of the same two assets over the same 5 day period. Accordingly, Asset A has a value of 934.82 at the inception of the index, a closing value of 917.87 on day 1, 934.82 on day 2, 947.95 on day 3, 940.86 on day 4 and 962.27 on day 5. As with the chart 10 of FIG. 3 the single day percent change in Asset A shown in Chart 30 is −1.81% for day 1, +1.85 for day 2, +1.40 for day 3, −0.75 for day 4 and +2.28 for day 5. Meanwhile Asset B had a starting value of 8823.93 at the start of the index. Asset B closed at 8694.09 at the end of day 1, 8824.41 at the end of day 2, 8919.01 at the end of day 3, 8872.96 at the end of day 4, and 9053.64 at the end of day 5. Thus, the single day percentage change for Asset B was −1.47 for day 1, +1.50 for day 2, +1.07 for day 3, −0.52 for day 4 and +2.04 for day 5. Applying formula (3) for calculating the average daily performance index, the index has a value of 99.66 at the end of day 1, 99.84 at the end of day 2, 99.95 at the end of day 3, 99.89 at the end of day 4 and 99.94 at the close of day 5.

For comparison purposes the performance of Assets A and B and the average daily performance index are shown in line graph form in FIGS. 8(a), 8(b) and 8(c). The charts of FIGS. 8(a) and 8(b) are identical to those of FIGS. 3(a), 3(b) and 6(a), 6(b) since they reflect the performance of the same assets over the same time period. The chart in FIG. 8(c), however, is significantly different than that of FIGS. 3(c) and 6(c) since the average daily performance index measures a substantially different aspect of the relative performance between Assets A and B.

Derivative investment instruments such as futures and options contracts may be traded based on the average daily performance index just as with traditional market indexes. Such contracts will have fixed expiration dates. Unlike the first embodiment, the average daily performance index is not reset at the end of each trading session. Thus there is no need to settle positions at the end of each session. Rather, all positions are settled in cash upon expiration.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A method of creating an index adapted to reflect the relative performance of a plurality of assets, the method comprising the steps of:
selecting a plurality of assets;
monitoring the value of each asset among the plurality of assets;
calculating an index value which reflects relative changes between the value of each asset according to a formula
I_{index value}=100+X(Δ%A₁)−Y(Δ%A₂)
where X and Y are separately adjustable multipliers, Δ% A1 is a one day percentage change in the value of the first asset, and Δ% A2 is a one day percentage change in the value of the second asset;
determining an expiration date for a derivative investment instrument based on the index value; and
resetting the index value to a base value at predefined times regardless of the value of each asset.

2. The method of claim 1 further comprising the step of creating a plurality of regular trading sessions, wherein the index value is reset to a base value between the end of each trading session and the start of a next trading session.

3. The method of claim 1 wherein the percentage change of the values of the first and second assets is measured from the base value of the index.

4. The method of claim 1 wherein the first and second assets comprise one or more of commodities, securities, derivatives or economic indicators.
